(19) United States
(12) Patent Application Publication
(10) Pub. No.: US 2026/0331882 A1
(43) Pub. Date: Oct. 22, 2026

(54) CONNECTING DEVICE, SWITCHGEAR ASSEMBLY HAVING A CONNECTING DEVICE AND METHOD FOR AUTOMATICALLY CONNECTING AND DISCONNECTING THE CONNECTING DEVICE

(71) Applicant: Siemens Mobility GmbH, München (DE)

(72) Inventors: Stefan Kohlwes, Neunkirchen am Brand (DE); Dennis Schütz, Erlangen (DE)

(21) Appl. No.: 19/104,442

(22) PCT Filed: Jul. 19, 2023
(86) PCT No.: PCT/EP2023/070038

§ 371 Date: Feb. 18, 2025

(30) Foreign Application Priority Data
Aug. 18, 2022 (DE) 10 2022 208 590.6

(51) Int. Cl. H02B 11/133; H01R 13/629; H01R 13/631; H01R 13/635; H01R 43/26

(52) U.S. Cl. CPC H02B 11/133; H01R 13/62905; H01R 13/631; H01R 13/635; H01R 43/26

(57) ABSTRACT

A connecting device of a switchgear assembly has at least one control line with at least two parts. A first part is connected to a fixed part of a switchgear cabinet of the switchgear assembly and a second part is connected to a moving part of the switchgear cabinet of the switchgear assembly. The moving part of the switchgear cabinet is displaceable, and the connection of the second part to the first part of the connecting device can be produced by displacing the moving part of the switchgear cabinet of the switchgear assembly. The connection to the at least one control line of the switchgear assembly can be produced automatically by producing the connection of the second part to the first part of the connecting device.

The invention relates to a connecting device of a switchgear assembly, to a switchgear assembly with at least one connecting device and to a method for automatic connection and to a method for automatic disconnection of the connecting device.

As a rule, switchgear assemblies, for example DC or AC switchgear assemblies, switchgear assemblies for supplying power to railroads or for a railroad power supply network, for buildings such as for example a station, etc., for industrial systems, blast furnaces, etc., have corresponding switchgear cabinets with fixed and mobile parts.

Such a switchgear assembly with one or more switchgear cabinets can for example also be part of a substation of a railroad track or of a railroad track network for supplying the overhead line of a section of track of this railroad track. Such substations with the corresponding switchgear assemblies are usually present separately for each section of track of a railroad track of a railroad track network.

As a rule switchgear assemblies have inter alia high-speed circuit breakers as well as control lines or control line cables, for which there is provision for the intentional disconnection from or connection to the rest of the system, in particular during or for the purposes of maintenance in one or more switchgear cabinets assigned to the switchgear assembly.

To this end parts of the switchgear cabinets are designed as mobile, for example as drawers, slide-in units or trucks, etc., for such high-speed circuit breakers as well as control lines or control line cables, in order to enable explicit disconnection from the system to be undertaken. For example corresponding trucks are arranged for this purpose so that they can be moved into and out of the associated switchgear cabinet. Before they are moved out or pulled out, the control line cable or cables (usually 30-50-wire) must be unplugged, i.e. disconnected, and plugged back in again, i.e. connected, when moved back in. Depending on the design of the trucks this occurs either before or after the truck is moved or pushed into the switchgear cabinet.

As a rule, current solutions use stiff, cumbersome cables with industrial connectors with locking frames, which have to be unlocked manually and unplugged before the unit is moved or pulled out and have to be plugged back in and locked again manually before the unit is moved or pushed in. The control line cable concerned must moreover be fixed accordingly after being unplugged, so that it cannot be damaged during inwards or outwards movement of the switchgear truck. In such cases there is also the danger of the maintenance personnel forgetting to reconnect the plug-in connection at the end of the process.

Over and above this, in particular in relation to switchgear assemblies for railroad power supply in accordance with rail standards, two settings within the switchgear cabinet are defined, which accordingly always have to be taken into account, in particular during maintenance work. One of the defined settings is the operating setting, in which the high-speed circuit breaker or breakers is or are completely in contact with the switchgear cabinet, i.e. all main contacts and auxiliary contacts or circuits are closed or connected. The second defined setting is the test setting, in which the main contacts are disconnected but the auxiliary contacts remain connected or closed. Here, for a safe disconnection of the main contacts in the test setting, appropriate air gaps from live parts must be or must remain guaranteed.

This is currently achieved, at least in a few cases, by the high-speed circuit breaker or breakers being self-driven, which in its turn brings with it other difficulties, such as for example the necessity for mutual locking of the mobile part and the circuit breaker, which is very complex in its construction and operation.

The object underlying the invention is to specify a connecting device of a switchgear assembly, a switchgear assembly with connecting device and also a method for automatic connection as well as a method for automatic disconnection of the connecting device, with which on the one hand the connection to and on the other hand the disconnection from a control line of the switchgear assembly is improved.

The object is achieved by the features of independent claim 1 and also of subordinate claims 17, 18 and 19. Developments and embodiments of the invention can be found in the features of the dependent claims.

To this end the connecting device of a switchgear assembly with at least one control line has at least two parts, wherein one part is connected to a fixed part of a switchgear cabinet of the switchgear assembly and the second part is connected to a mobile part of the switchgear cabinet of the switchgear assembly, wherein the mobile part of the switchgear cabinet can be pushed and wherein the connection of the second part to the first part of the connecting device can be established by means of pushing the mobile part of the switchgear cabinet of the switchgear assembly, wherein the connection to the at least one control line of the switchgear assembly can be established automatically by means of establishing the connection of the second part to the first part of the connecting device.

According to an especially preferred embodiment of the invention, the connection of the second part to the first part of the connecting device can be disconnected by pulling the mobile part of the switchgear cabinet of the switchgear assembly, wherein the connection to the at least one control line of the switchgear assembly can be disconnected automatically by means of disconnecting the connection between the second part and the first part of the connecting device.

The inventive solution has the advantage that the control line(s) is or are connected or disconnected automatically. The connection of the control line(s) can accordingly be established significantly more quickly and with fewer manual actions and also disconnected again. This enables the user friendliness to be greatly enhanced. What is more the operating personnel do not forget to plug in the control line or the control line cable when the assembly is moved in or pushed in, i.e. in order to establish the connection. Rapid and error-free operation is thus ensured.

According to a further especially preferred embodiment of the invention, the mobile part of the switchgear cabinet of the switchgear assembly is designed as a truck, wherein the truck is able to be pushed into the switchgear cabinet of the switchgear assembly. A truck enables heavy and/or large loads, for example high-speed circuit breakers, to be transported back and forth especially easily. As a consequence the connection or disconnection of the control line(s) is established even more rapidly and easily by simply pushing in and pulling out the unit. Thus the automatic disconnection or establishing of the connection of the control line(s) can be brought about in an especially trouble-free way by moving the truck, for example the high-speed circuit breaker truck, in and out.

According to a further preferred embodiment of the invention, the first and the second part of the connecting device each have a plug-in connecting component, by means of which the first and the second part of the connecting device are able to be connected to one another as a plug-in connection.

Especially preferably the plug-in connection is self-centering.

This has the advantage that a secure connection between the male and female part of the contacts and thus a permanent contact connection, in particular of the control line(s) can be ensured. What is more, the self-centering plug-in connection takes account of tolerances in the breaker truck position within the cabinet in a simple manner, whereby damage can be avoided during the plug-in process.

According to a further especially preferred embodiment of the invention, the second part of the connecting device has at least one mobile component, wherein the at least one mobile component of the second part, in the connected state of the connecting device, is able to be displaced in the direction of the first part up to an end position. Especially preferably the at least one mobile component of the second part, in the connected state of the connecting device, is able to be displaced in the direction of the first part at least 90 mm up to the end position.

This has the advantage that, after the connection of the control line(s) has been established, i.e. after the two plug-in components of the first and the second part of the connecting device are connected to one another, of which the mobile component of the second part, while maintaining or retaining the connection of the control line(s) can move further in the direction of the first part of the connecting device, preferably by means of telescopic bars, up to an end position constructively defined on the fixed part of the switchgear cabinet or of the first part of the connecting device, for example by a corresponding stable stop, is reached. The realization of this movement is not restricted to the application of telescopic bars in this case. All other possible and sensible alternative solutions, such as for example rollers, etc., can be used here.

This enables, in particular in the field of rail vehicles, i.e. for example with switchgear assemblies for railroad power supply or a railroad power supply network, specific specifications or requirements in particular also for maintenance work, which arises in accordance with corresponding rail standards to be taken into account, always to be adhered to or implemented without constraints. In this way in accordance with rail standards, in particular two positions are defined within the switchgear cabinet. One of the defined positions is the operating position, in which the high-speed circuit breaker or breakers is or are completely in contact with the switchgear cabinet, i.e. all main contacts and auxiliary contacts or circuits are closed or connected. The second defined position is the test position, in which the main contacts are disconnected, the auxiliary contacts, i.e. in particular the control line(s), remain connected or closed however. Here, in the test position, for a safe disconnection of the main contacts, corresponding air gaps to live parts must be guaranteed or must remain. This is achieved in particular by the form of embodiment of the invention described above, which makes it possible to displace the mobile components of the second part of the connecting device by at least 90 mm, whereby a corresponding, sufficiently large air gap can be guaranteed.

Accordingly, the point in time at which the two plug-in components of the first and the second part of the connecting device are connected to one another, i.e. the connection of the control line(s) is established, corresponds to the test setting.

Thus, especially with the further moving in or pushing in, for example of a truck of a slide-in unit with the mobile components of the second part of the connecting device as far as the end position, which corresponds to the operating setting, it is made possible for the connection of the control line(s) to continue to be in place until the operating position is reached. When the unit, for example the breaker truck etc., is pulled out or moved out of the switchgear cabinet from the end position, i.e. the operating position, the end stop in the end position accepts the force for disconnection of the plug-in connection of the connecting device.

According to a further especially preferred embodiment of the invention, the second part of the connecting device has at least one compression apparatus, by means of which the connection of the second part to the first part of the connecting device is able to be established. The compression apparatus in this case is preferably at least in some cases part of the mobile component of the second part of the connecting device and especially preferably has a stop and a movable counter stop, wherein in the idle position of the compression apparatus the stop and the counter stop lie next to one another.

Preferably the stop of the compression apparatus is designed as a raised area and especially preferably is square in shape. The counter stop of the compression apparatus preferably has at least one roller lever and a spring element, wherein the spring element is especially preferably designed as a pneumatic spring.

In this case, according to an especially preferred form of embodiment of the invention, by means of the action of a compressive force on the counter stop of the compression apparatus, the stop is able to be overcome by the counter stop and by means of the compressive force with which the stop of the compression apparatus is able to be overcome by the counter stop, a counter pressure can preferably be exerted on the plug-in connection components of the first and the second part of the connecting device, by means of which the connection between the second part and the first part of the connecting device is able to be established.

Thus, with the inventive form of embodiment, a mechanism, for example on a truck, in particular a breaker truck, or in a drawer or a slide-in unit etc., is built in that, when pressure is exerted on the counter stop of the compression apparatus of the second part of the connecting device by the pushing in, of the truck for example, starting from the idle position of the compression apparatus, in which the stop and counter stop can be next to one another or, depending on the requirement, can also rest against one another, ensures the creation of an adequate counter force in order to establish the plug-in connection of the connecting device and thus the connection of the control line(s) in a safe and stable manner. In this case the box-shaped design of the raised part or of the stop of the compression apparatus in particular forms both a suitable vertical surface transverse to the direction of movement of the mobile components of the second part of the connecting device and also the necessary height that has to be overcome in order to build up the necessary pressure or counter pressure. The stop itself is in this case not part of the mobile components of the second part of the connecting device for making possible the build-up of the corresponding pressure or counter pressure. The dimensions and in particular the geometrical shape of the stop can be adapted arbitrarily in this case without restriction depending on the requirement. The embodiment of the counter stop with a roller lever and spring element enables to force effect needed, in particular the compressive force for overcoming the stop and simultaneous establishment of the connection, i.e. the plugging in of the control line(s) to be dispensed in a particularly precise and exact manner. This is further enhanced by the preferred use of a pneumatic spring or gas-filled spring device. After the stop or at least a part of the stop has been overcome, for example a vertical surface of a box-shaped raised area, the use of a roller lever, with further inwards movement or pushing in, causes the mobile components to be able to move without counter pressure further in the direction of the switchgear cabinet up to the end position, while the connection of the control line(s) continues to exist. The roller lever moves in this case, after leaving or overcoming the vertical surface for example, on the box-shaped raised area along the horizontal cover surface of the raised area or of the stop. The length of the possible movement in this case can be dimensioned as required. If a corresponding long air gap for a secure disconnection of contacts, in particular of main contacts from live parts is needed or requested, then the corresponding length can be expanded to at least 90 mm or also to significantly longer without any problem.

A switchgear assembly with at least one inventive connecting device as claimed in one of claims 1 to 16 correspondingly has the advantages of the invention explained further above.

A further aspect of the present invention relates to a method for automatic connection of at least one control line of a switchgear assembly by means of at least one connecting device as claimed in one of claims 1 to 16 with the following steps:
pushing the mobile part of the switchgear cabinet of the switchgear assembly to which the second part of the connecting device is connected, in the direction of the fixed part of the switchgear cabinet of the switchgear assembly, to which the first part of the connecting device is connected;
establishing the connection between the second part and the first part of the connecting device;
automatically establishing the connection of the at least one control line of the switchgear assembly by means of establishing the connection between the second part and the first part of the connecting device.

A further aspect of the present invention relates to a method for automatic disconnection of at least one control line of a switchgear assembly by means of at least one connecting device in one of claims 1 to 16 with the following steps:
pulling as claimed the mobile part of the switchgear cabinet of the switchgear assembly to which the second part of the connecting device is connected, away from the fixed part of the switchgear cabinet of the switchgear assembly to which the first part of the connecting device is connected;
disconnecting the connection between the second part and the first part of the connecting device;
automatically disconnecting the connection of the at least one control line of the switchgear assembly by means of disconnecting the connection of the second part from the first part of the connecting device.

With the inventive method described a very quick method needing just a few manual operations for both automatic establishment and also automatic disconnection of control line(s) from switchgear assemblies is possible, whereby the user friendliness is greatly enhanced. What is more, the operating personnel cannot forget to plug in the control line or the control line cable when moving or pushing the unit in, i.e. when establishing the connection. Thus a rapid and error-free operation is ensured.

Preferred exemplary embodiments of the invention are explained in more detail below with reference to the drawings, in the figures:

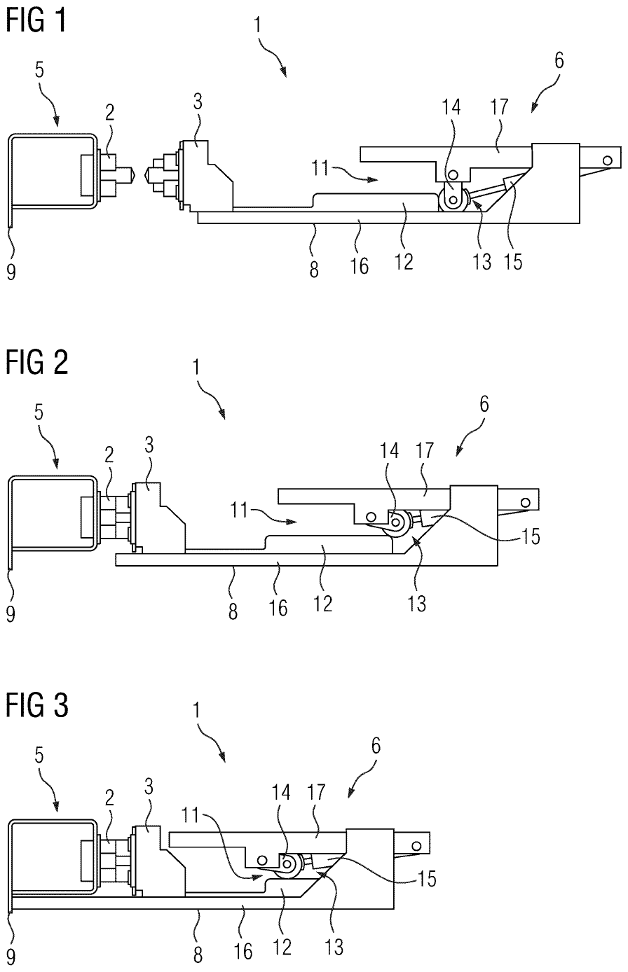

FIG. 1 shows an inventive connecting device in the disconnected state,

FIG. 2 shows an inventive connecting device in the connected state,

FIG. 3 shows an inventive connecting device in the connected state in the end stop position,

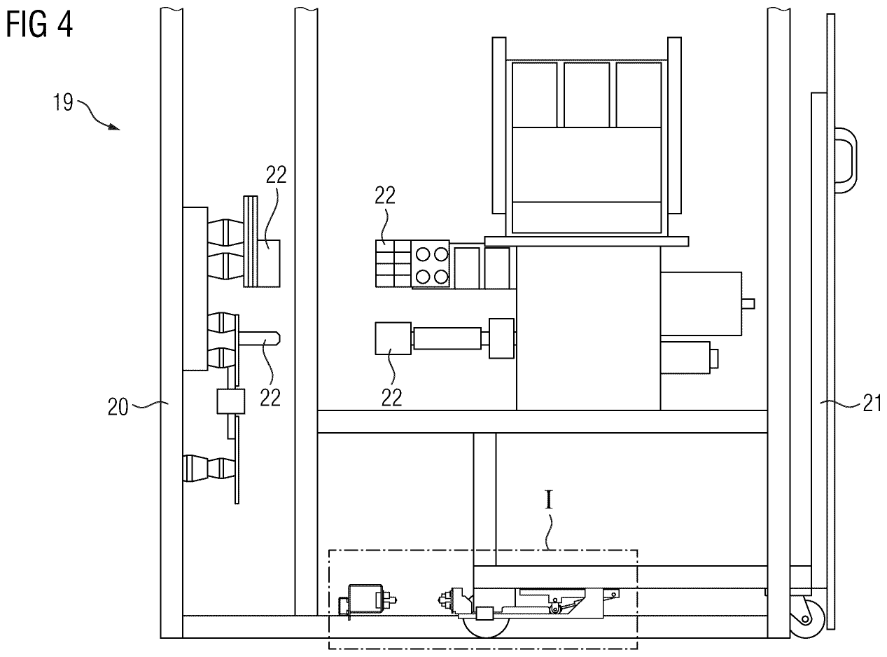

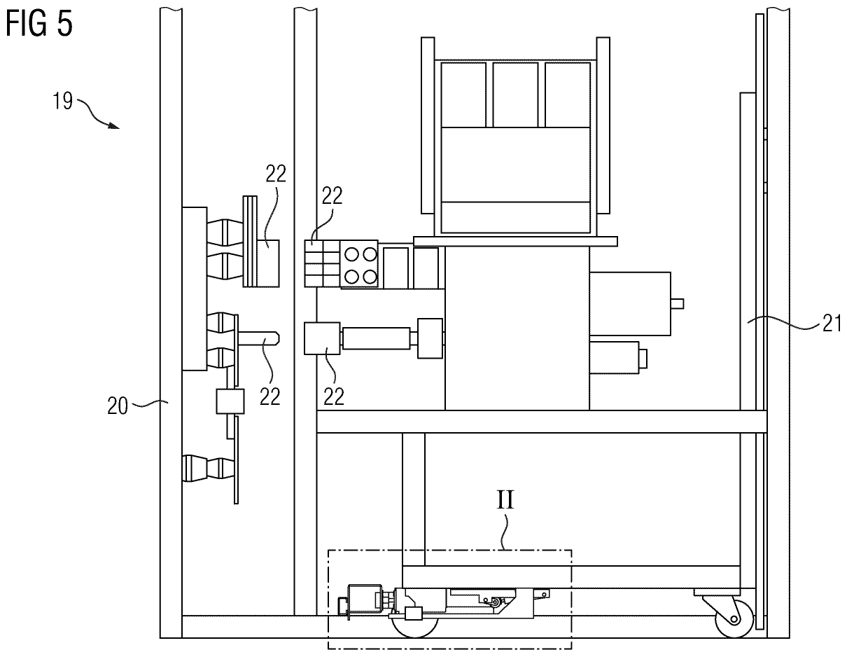

FIG. 4 shows a switchgear cabinet with the inventive connecting device in the disconnected state in accordance with FIGS. 1,

FIG. 5 shows a switchgear cabinet with the inventive connecting device in the connected state in accordance with FIGS. 2,

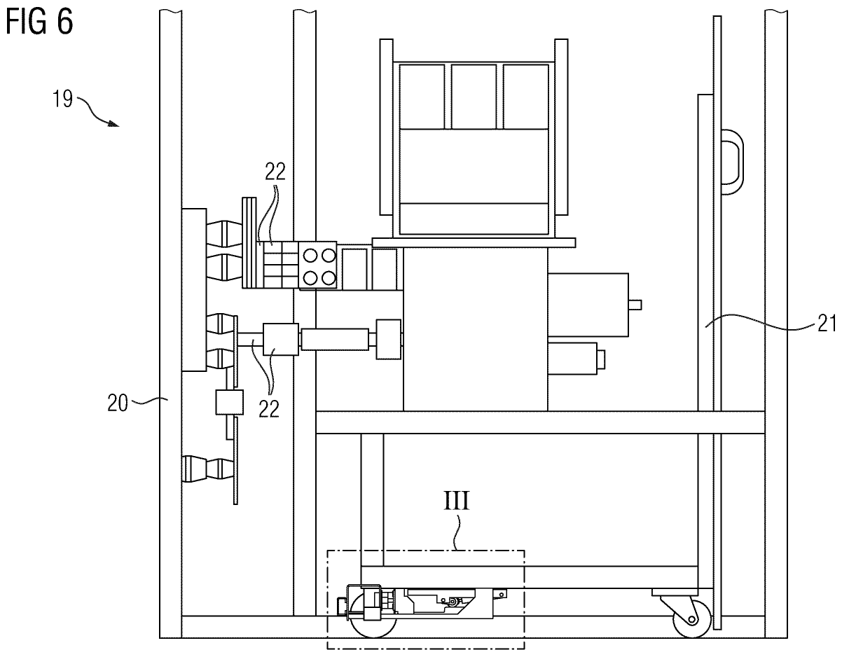

FIG. 6 shows a switchgear cabinet with the inventive connecting device in the connected state in the end stop position in accordance with FIG. 3.

In FIGS. 1 to 6 the same components are identified by the same reference numbers in each case. In this case explicit reference is made in FIGS. 4 to 6 in each case to the detailed diagram of the corresponding FIGS. 1 to 3 for said figures. The depiction of the forms of embodiment can differ where necessary in such cases. Only the differences in relation to the other figures are described in the respective figure descriptions, the common elements naturally continue to apply, even without this being stated explicitly.

FIG. 1 shows a form of embodiment of the inventive connecting device 1 in the disconnected state, consisting of a first part 5, which is permanently connected to a fixed part 20 of a switchgear cabinet 19, and a second part 6, which is connected to a mobile part 21 of a switchgear cabinet 19 (see also FIGS. 4 to 6 in this regard, in which the exemplary embodiments are shown with switchgear cabinet 19). As shown in FIG. 1, the first part 5 and the second part 6 of the connecting device are disconnected, whereby the connection of the control line(s) is also disconnected.

The first part 5 of the connecting device 1 essentially consists of a cabinet-side plug-in connection component 2 and an end stop 9, which characterizes or defines an end position of the second part 6. The end stop 9 is connected here via a metallic frame to the cabinet-side plug-in connection component 2. The first part 5 of the connecting device 1 is essentially embodied as non-mobile and at a fixed location.

The second part 6 of the connecting device 1 essentially consists of a plug-in connection component 3, which is connected to the mobile part 21 of the switchgear cabinet 19, i.e. on the truck side for example, a mobile component 8 and a stop 12, which is designed here as a box-shaped raised area and is part of the compression apparatus 11. The raised area 12, by contrast with the further element of the compression apparatus, is embodied in a fixed location with respect to the counter stop 13 in order to make it possible for a corresponding pressure or counter pressure to be built up by the counter stop 13. The counter stop 13 of the compression apparatus 11 consists, in accordance with one form of embodiment of FIG. 1, of a roller lever 14, which is coupled to a pneumatic spring or gas-filled spring device 15. In the state of the compression apparatus 11 shown in FIG. 1, the roller lever 14 has left the initial idle position, in which the raised area 12 and the roller lever 14 generally lie next to one, and already lies directly next to the raised area 12 and is touching said area. The counter stop 13 of the compression apparatus 11, in particular the gas-filled spring device 15 is connected in this case to the holder 17 of the second part 6 of the connecting device 1. The holder 17 in this case, as is shown, is connected by means of a lateral connection, for example a lateral plate, to at least one telescopic rail 16, which is part of the mobile component 8 and guarantees the movement of the second part 6 in the direction of the first part 5 of the connecting device 1. Starting from the disconnected state of the connecting device 1 shown in FIG. 1, the second part 6 of the connecting device 1 moves, with the exception of the fixed raised area 12, during insertion for example of an associated truck 21 (this is shown in FIGS. 4 to 6) further in the direction towards the first part 5 of the connecting device 1. The two plug-in connection components 2, 3 of the connecting device 1 have already come close enough to each other in accordance with the diagram shown in FIG. 1 for the establishment of the plug-in connection of the connecting device 1 and thus for the connection of the control line to be immediately imminent. In order to guarantee the plug-in connection especially securely and simply, a self-centering plug-in connection is used for this.

In order to guarantee the automatic establishment of the plug-in connection, consequently with the further insertion, of the truck 21 for example, a compressive force is exerted in particular on the compression apparatus 11, whereby the roller lever 14 in connection with pneumatic spring 15 rises up or is pushed up the vertical surface of the box-shaped raised area 12, on which the roller lever 14 is already resting and through this a corresponding counter pressure is built up, which leads, on further insertion into the switchgear cabinet 19, to the secure and stable plug-in connection of the plug-in connection components 2, 3 of the connecting device 1. This is achieved directly when the roller lever 14 has just reached or overcome the upper edge of the vertical surface of the raised area 12 and has arrived on the horizontal top surface of the raised area 12. This position is shown in FIG. 2. The plug-in connection 2, 3 of the connecting device 1 and thus the connection of the control line is established with the self-centering plug-in connection, as shown.

On further insertion of the truck 21 with the second part 6 of the connecting device 1 for example, starting from this position, the plug-in connection and thus the connection of the control line(s) remains in place and the plug-in connection components 2, 3 remain in a fixed location as from this position. The rest of the second part 6 of the connecting device 1 moves further in the direction towards the first part 5. In this case the roller lever 14 moves itself or travels without counter pressure further on the horizontal top surface of the raised area 12, until the second part 6 reaches the end position and with the telescopic rail or rails 16, hits the end stop 9 of the first part 5 of the connecting device 1, or has arrived at it. This position is shown in FIG. 3. In this position all connections are then restored. For automatic disconnection of the connection(s) the second part 6 is pulled away from or out of the first part 5 of the connecting device 1, whereby the automatic disconnection process takes place essentially conversely to the automatic establishment of the connection(s).

Illustrated correspondingly in FIGS. 4 to 6 with the aid of a form of embodiment employed in the rail vehicle field is the process that was previously described for FIG. 1 to 3. To this end explicit reference is made in FIG. 4 to 6 to FIGS. 1 to 3, in particular in FIG. 4 to FIG. 1 (I), in FIG. 5 to FIG. 2 (II) and in FIG. 6 to FIG. 3 (III).

In particular with switchgear assemblies for a railroad power supply or for a railroad power supply network, in accordance with rail standards specific specifications or requirements, in particular during maintenance work as well, are to be adhered to. Thus two positions in particular within switchgear cabinets are defined here. One of the defined positions is the operating position, in which one or more high-speed circuit breakers is or are completely in contact with the switchgear cabinet, i.e. all main contacts and auxiliary contacts or circuits are closed or connected. The second defined position is the test position, in which the main contacts are disconnected, but the auxiliary contacts, i.e. in particular the control line(s), remain connected or closed however. Here, for a secure disconnection of the main contacts, corresponding air gaps to live parts must be guaranteed or remain in the test position.

FIG. 4, using the form of embodiment in FIG. 1 (I), shows a switchgear cabinet 19 with a fixed part 20 and a mobile part, with the truck 21, on which in the upper area for example a high-speed circuit breaker is located and in the lower area of the truck 21 the connecting device 1 in accordance with FIG. 1 is arranged. This arrangement is not restrictive however, but, depending on requirement, can be in any given sensible place or at any given location of the truck 21.

FIG. 4 shows the completely disconnected state of all main contacts 22 as well as the auxiliary contacts, in particular of the control line or of the associated inventive connecting device 1.

If the truck 21 is pushed further into the switchgear cabinet 19 in the direction towards the fixed part 20, the test position is reached in FIG. 5. The plug-in connection 2, 3 of the connecting device 1 and thus the connection of the control line is already established automatically in accordance with the form of embodiment of FIG. 2 (II) by means of pushing the truck 21 into this position. The main contacts 22 are still disconnected from one another. For secure disconnection the connecting device 1 is designed in such a way that, in this position, an air gap of at least 90 mm exists between the open contacts of the main contacts 22, i.e. the live parts. The length of the air gap, depending on requirement, can also be expanded as required by a corresponding embodiment of the connecting device 1.

When the truck 21 is pushed further into the switchgear cabinet 19, the operating position is reached in FIGS. 6, in which, in accordance with the form of embodiment of FIG. 3 (III), as well as the already established plug-in connection 2, 3 of the connecting device 1 and thus the established connection of the control line, which also remains in place during the insertion, the connection of all main contacts 22 is now also established automatically, so that now all connections are restored again.

For automatic disconnection of the connection(s) the truck 21 is pulled away from the fixed part 20 and is pulled out of the switchgear cabinet 19, whereby the automatic disconnection process essentially takes place as the reverse of the automatic establishment of the connection(s).

1-19. (canceled)

20. A connecting device of a switchgear assembly with at least one control line, the connecting device comprising:
at least two parts including a first part connected to a fixed part of a switchgear cabinet of the switchgear assembly and a second part connected to a mobile part of the switchgear cabinet of the switchgear assembly, wherein the mobile part of the switchgear cabinet is displaceable, wherein by means of pushing in the mobile part of the switchgear cabinet of the switchgear assembly, a connection of said second part to said first part of the connecting device is established, wherein by means of establishing the connection of said second part to said first part of the connecting device a connection to the at least one control line of the switchgear assembly is automatically established.

21. The connecting device according to claim 20, wherein the mobile part of the switchgear cabinet of the switchgear assembly is embodied as a truck, wherein the truck is able to be pushed into the switchgear cabinet of the switchgear assembly.

22. The connecting device according to claim 20, where said first part and said second part each have a plug-in connection component, by means of which said first part and said second part of the connecting device can be connected to one another as a plug-in connection.

23. The connecting device according to claim 22, wherein said plug-in connection is self-centering.

24. The connecting device according to claim 20, wherein said second part of the connecting device has at least one mobile component, wherein said at least one mobile component of said second part, in a connected state of the connecting device, is displaceable in a direction of said first part up to an end position.

25. The connecting device according to claim 24, wherein said at least one mobile component of said second part, in the connected state of the connecting device, is displaceable in the direction of said first part by at least 90 mm up to the end position.

26. The connecting device according to claim 20, wherein said second part of the connecting device has at least one compression apparatus, by means of said at least one compression apparatus the connection of said second part to said first part of the connecting device is established.

27. The connecting device according to claim 26, wherein said at least one compression apparatus is a part of said at least one mobile component of said second part of the connecting device.

28. The connecting device according to claim 26, wherein said at least one compression apparatus has a stop and a movable counter stop, wherein in an idle position of said at least one compression apparatus said stop and said movable counter stop lie next to one another.

29. The connecting device according to claim 28, wherein said stop of said at least one compression apparatus is embodied as a raised area.

30. The connecting device according to claim 29, wherein said raised area is embodied in a shape of a box.

31. The connecting device according to claim 28, wherein said movable counter stop of said at least one compression apparatus has at least one roller lever and a spring element.

32. The connecting device according to claim 31, wherein said spring element is embodied as a pneumatic spring.

33. The connecting device according to claim 28, wherein by means of an influence of a compressive force on said movable counter stop of said at least one compression apparatus, said stop is able to be overcome by said movable counter stop.

34. The connecting device according to claim 33, wherein by means of the compressive force with which said stop of said at least one compression apparatus is able to be overcome by said movable counter stop, a counter pressure is exerted on said first part and said second part of said connecting device, by means of which the connection of said second part to said first part of the connecting device is established.

35. The connecting device according to claim 20, wherein by means of pulling the mobile part of the switchgear cabinet of the switchgear assembly, said connection of said second part to said first part of the connecting device is disconnected, wherein by means of disconnection of said connection of said second part from said first part of the connecting device, the connection with the at least one control line of the switchgear assembly is disconnected automatically.

36. A switchgear assembly, comprising:
said connecting device according to claim 20.

37. A method for automatic connection of at least one control line of a switchgear assembly by means of the connecting device according to claim 20, which comprises the following steps of:
pushing the mobile part of the switchgear cabinet of the switchgear assembly to which the second part of the connecting device is connected, in a direction towards the fixed part of the switchgear cabinet of the switchgear assembly, to which the first part of the connecting device is connected;
establishing the connection between the second part and the first part of the connecting device; and
automatically establishing the connection of the at least one control line of the switchgear assembly by means of establishing the connection between the second part and the first part of the connecting device.

38. A method for automatic disconnection of at least one control line of a switchgear assembly by means of the connecting device according to claim 20, which comprises the following steps of:
pulling the mobile part of the switchgear cabinet of the switchgear assembly, to which the second part of the connecting device is connected, away from the fixed part of the switchgear cabinet of the switchgear assembly, to which the first part of the connecting device is connected;
disconnecting the connection of the second part from the first part of the connecting device; and
automatically disconnecting the connection of the at least one control line of the switchgear assembly by means of disconnection of the connection of the second part from the first part of the connecting device.
